(19) United States
(12) Patent Application Publication
(10) Pub. No.: US 2019/0119938 A1
(43) Pub. Date: Apr. 25, 2019

(54) LIGHTWEIGHT ECO-CONSCIOUS COMPOSITE UTILITY POLE

(71) Applicant: COMPOSIPOLE INC., Cottonwood Heights, UT (US)

(72) Inventors: THOMAS J. SORENSON, Cottonwood Heights, UT (US); B. JAY LARSON, Salt Lake City, UT (US)

(21) Appl. No.: 16/168,582

(22) Filed: Oct. 23, 2018

Related U.S. Application Data
(60) Provisional application No. 62/575,889, filed on Oct. 23, 2017.

(51) Int. Cl. E04H 12/02; B29C 70/32

(52) U.S. Cl. CPC E04H 12/02; B29L 2023/22; B29C 70/32

(57) ABSTRACT

Disclosed embodiments include hollow composite utility pole structures and methods of manufacture of the same using ring winding process. Poles may be manufactured using a resin impregnated, or resin wetted filament roving that is wound onto a mandrel from several delivery points arranged circumferentially around mandrel axis. Various pole structures and manufacturing methods are described, including chemically bonded sleeve joint structures for poles of varying size.

### CROSS-REFERENCE TO RELATED APPLICATIONS

This application, under 35 U.S.C. § 119, claims the benefit of U.S. Provisional Patent Application Ser. No. 62/575,889 filed on Oct. 23, 2017, and entitled “Lightweight, Eco-Conscious Composite Utility Pole,” the contents of which are hereby incorporated by reference herein.

### FIELD OF THE DISCLOSURE

This disclosure relates generally to systems and methods for making composite parts. In particular, systems and methods of manufacture are disclosed for composite utility pole structures including, but not limited to, pole structures for power distribution and communications.

### BACKGROUND

In this specification where a document, act or item of knowledge is referred to or discussed, this reference or discussion is not an admission that the document, act or item of knowledge, or any combination thereof, was at the priority date, publicly available, known to the public, part of common general knowledge, or otherwise constitutes prior art under the applicable statutory provisions; or is known to be relevant to an attempt to solve any problem with which this specification is concerned.

Embodiments of the present disclosure relate to protecting the environment from soil contamination due to creosol, or other substances, leaching from current wood technology utility poles, while providing a significantly lighter weight pole utilizing composite materials, and greater service life. For example, typical coatings can include creosote (an OSHA restricted carcinogen), pentachlorophenol (an EU banned substance), copper naphthenate (a substance with indoor use restrictions), and chromate copper arsenate (an EPA restricted substance).

Over time partially buried creosol impregnated wood utility poles leach hazardous creosol, and other potentially harmful substances, into the soil because of things like changing soil moisture and temperatures. Likewise, steel and cement poles can leach harmful substances into the soil. Utility companies in states with soil contamination regulations are required to monitor the soil around these poles, and remove the poles when, for example, the creosol in the soil exceeds the requirements. Some utility companies are replacing over 5,000 poles per year due to soil contamination.

Typically, the overall service life of current technology wood utility poles is limited to 20-50 years, based on, among other things, the exposure to the outdoor environments where the poles are installed. The seasonal moisture and freeze-thaw cycles remove the creosol from the wood, and, thus, the poles crack and split requiring replacement.

As the service life on the current wood poles is exceeded, and replacement is required, there can be issues with access to the wood poles for heavy removal equipment. Because some poles are located in densely populated areas, structures and buildings may have been constructed adjacent to the utility poles significantly limiting access for heavy equipment. To remove poles with limited access, helicopters are required since the wood poles can weigh approximately 800-1200 pounds each, and steel and concrete poles can weigh more than wood poles. Additionally, wood poles require the growing and logging of timber of sufficient size, a time-consuming and relatively costly enterprise.

Furthermore, current technology creosol impregnated wood poles are susceptible to catch fire when the power line fails or short-circuits, or when forest fires occur. Likewise, wildlife, such as woodpeckers, rodents, beavers, termites, and others, can damage wood poles. Fumigation, pesticides, soil treatments, and other chemical schemes to alleviate wildlife or insect damage, are potentially environmentally dangerous as well. Other drawbacks, disadvantages, and inconveniences of existing systems and methods also exist.

### SUMMARY

Accordingly, disclosed systems and methods address the above-noted, and other, issues of existing systems and methods. For example, the presently disclosed systems and methods provide stronger, lightweight alternatives to the wood, cement, and steel poles used today that do not require heavy service cranes, or multiple boom trucks, to deploy.

The presently disclosed composite materials are substantially impervious, or at least resistant to the effects of moisture, and leach no hazardous materials in the soil. Therefore, the need to replace poles due to contaminated soil has been substantially lessened, or eliminated. In addition, the creep strength characteristics of the disclosed composite materials are a significant improvement over wood, and therefore the composite pole does not experience permanent-set due to the constant loading from the utility equipment, power lines, guy-wires, and the like. The disclosed composite laminate design, or helical winding angles, have been optimized with a higher percentage of low angle (5° to 30°) helicals to efficiently react the high bending loads at the base of the pole.

In addition, the disclosed composite fiber and resin materials are not effect by the weather, and therefore the service life is greater than 50 years for the disclosed composite utility poles. Further, the lighter weight of the disclosed composite utility poles allows for the removal and erection of the composite poles without heavy lifting equipment. The reduced weight composite utility poles are also easier and cheaper to store and transport to job sites, or the like.

In addition, the presently disclosed poles may be manufactured from non-flammable materials, making the utility pole fire resistant. The disclosed materials of the composite utility poles are less likely to ignite under the environments of a short circuit or power line failure.

Additionally, the disclosed composite poles may be directly buried and do not require chemical coatings or ground pre-treatment. The disclosed composite poles are also resistant to wildlife, insect, and the like, damage.

The present disclosure relates generally to embodiments of a light weight utility pole that does not contaminate the soil surrounding the pole with creosol throughout the life time of the pole. Because of the selected materials used in the manufacture of the composite utility pole with composite eco-conscious basalt fiber and pine based resin system, the disclosed embodiments are resistant to chemical migration of hazardous materials into the surrounding soil. The design of the composite utility pole and materials addresses the need to remove the utility pole and extends its service life. In addition, since the presently disclosed materials are non-combustible, the pole will not catch fire during a power failure or short-circuit event.

Presently disclosed embodiments provide a lighter weight utility pole that can be installed, or removed, without the use of heavy equipment, in locations that are restrictive and have limited access. A majority of the current technology utility poles in service are creosol impregnated wood poles that weight over 1000 pounds. When these poles need to be replaced due to environmental issues, in limited access locations, a helicopter must be employed. The lighter weight of presently disclosed embodiments of utility poles allows for the removal and erection of the composite poles without heavy lifting equipment.

Another disclosed embodiment includes a plurality of nested, tapered cylindrical multi-part poles (e.g., three sections for a 40 foot pole) that can be hand carried into limited access locations and erected by two men without heavy equipment. Other features, advantages, and conveniences of the disclosed systems and methods also exist.

Accordingly, disclosed embodiments include a hollow tapered composite utility pole including a plurality of fibrous rovings reinforcing a plastic matrix forming a hollow pole having an interior surface and an exterior surface and further having a narrow end, a wide end, and a taper portion extending between the narrow end and the wide end.

Further disclosed embodiments have a first bevel on the exterior surface of the pole at the narrow end, a second bevel on the interior surface of the pole at the wide end, and the first bevel and the second bevel are configured to couple and allow poles of varying sizes to be mated. In still further disclosed embodiments a chemical bonding agent is applied to at least one of the first bevel or the second bevel to couple the first bevel and the second bevel and to form a larger pole of modular construction.

In disclosed embodiments the plurality of fibrous rovings are applied 100-240 at a time. In further disclosed embodiments, the plurality of fibrous rovings are applied simultaneously and in a circumferential, manner to the longitudinal axis of a forming mandrel.

Also disclosed are methods of manufacturing a tapered composite utility pole, the method including ring winding a plurality of fibrous rovings reinforcing a plastic matrix to form a hollow pole having an interior surface and an exterior surface and further having a narrow end, a wide end, and a taper portion extending between the narrow end and the wide end.

In further disclosed embodiments the method includes applying the plurality of fibrous rovings 100-240 at a time, and simultaneously and in a circumferential, manner to the longitudinal axis of a forming mandrel.

In further disclosed embodiments, the method includes forming a first bevel on the exterior surface of the pole at the narrow end, forming a second bevel on the interior surface of the pole at the wide end, and wherein the first bevel and the second bevel are configured to couple and allow poles of varying sizes to be mated. In still further embodiments, the method included chemically bonding at least one of the first bevel or the second bevel to couple the first bevel and the second bevel and to form a larger pole of modular construction.

### BRIEF DESCRIPTION OF THE DRAWINGS

FIG. 1 depicts a one piece composite utility pole according to embodiments of the present disclosure.

FIG. 2 illustrates an upper portion of a composite utility pole according to embodiments of the present disclosure.

FIG. 3 depicts a sectional view a top portion of a composite utility pole according to embodiments of the present disclosure.

FIG. 4 depicts a detail and section view of a lower portion and varying cylinder wall thickness of a composite utility pole of FIG. 1.

FIGS. 5A-5B show a schematic illustration of existing, conventional winding machines.

FIG. 5C shows a schematic illustration of an embodiment of a Ring Filament Winding Machine used in embodiments of pole manufacture in accordance with embodiments of the present disclosure.

FIG. 6 is a schematic illustration of a natural fiber for use in the composite material in accordance with embodiments of the present disclosure.

FIG. 7 is a schematic illustration of a plurality of nested, tapered, cylindrical multi-part poles in accordance with embodiments of the present disclosure.

FIG. 8 is an illustration of a number of hollow cylinders manufactured in accordance with presently disclosed embodiments.

FIG. 9 is a schematic cross-sectional illustration of pole with beveled ends in accordance with disclosed embodiments.

FIG. 10 is a schematic view of a tapered pole 1 in accordance with disclosed embodiments.

FIG. 11 is a schematic side view of a ring winding system and process in accordance with disclosed embodiments.

FIG. 12 is a schematic end view of a ring winding system and process of FIG. 11 in accordance with disclosed embodiments.

FIG. 13 is a schematic end view of a conventional filament winding system and process of FIG. 14 in accordance with disclosed embodiments.

FIG. 14 is a side view schematic of a convention filament winding system in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

For a more complete understanding of the present disclosure and its advantages, reference is now made to the following description taken in conjunction with the accompanying drawings, in which like reference numerals represent like parts. The various embodiments disclosed herein are by way of illustration only and should not be construed in any way to limit the scope of the disclosure. Those skilled in the art will understand that the principles of the present disclosure may be implemented in any suitably arranged composite utility pole that is resistant to chemical migration of hazardous materials into the surrounding soil. As disclosed herein, the notational representations of cross sectional geometry presented are not intended to limit the configuration and wall thickness of the composite cylinders in embodiments of the present disclosure.

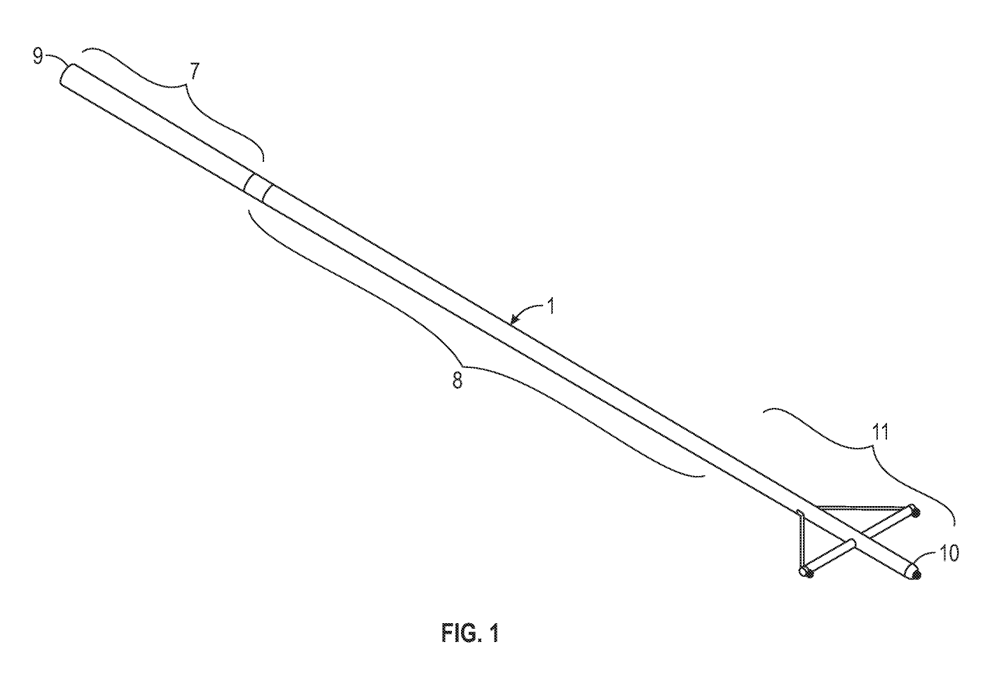

FIG. 1 is an isometric view of a one piece tapered composite utility pole 1 according to an exemplary embodiment of the present disclosure. Utility pole 1 is constructed of composite, plastic and metallic materials and is vertically erected with the lower six feet section 7 of the pole buried in the ground. Because of the selected materials used in the manufacture of the composite utility pole with composite eco-conscious basalt fiber and pine based resin system, presently disclosed embodiments are resistant to chemical migration of hazardous materials into the surrounding soil. The design of the pole 1 has a large diameter at the base 9 tapering to a smaller diameter at the top 10. The tapered design allows the cross-section and aerial inertia to vary along the length of the pole 1; optimizing the strength and weight of the utility pole 1 by providing increased strength at the regions of the pole 1 where higher bending loads exist from wind loading, or the like. The composite laminate design includes a plurality of composite plies with varying helical winding angles.

The composite materials selected for the manufacturing of the presently disclosed utility poles 1 provide many benefits. The disclosed, eco-conscious basalt fiber and pine based resin system are not only low cost, but provide, among other things, the following benefits: 1) a composite laminate which is resistant to chemical migration of hazardous materials into the surrounding soil; 2) non-flammable fiber and resin resulting in fire resistance; 3) improved material creep strength and reduced permanent-set from constant loading; 4) improved material dielectric constant increasing the electrical insulation capability of the pole; and 5) significant reduction in weight allowing the utility poles to be installed without heavy lifting equipment.

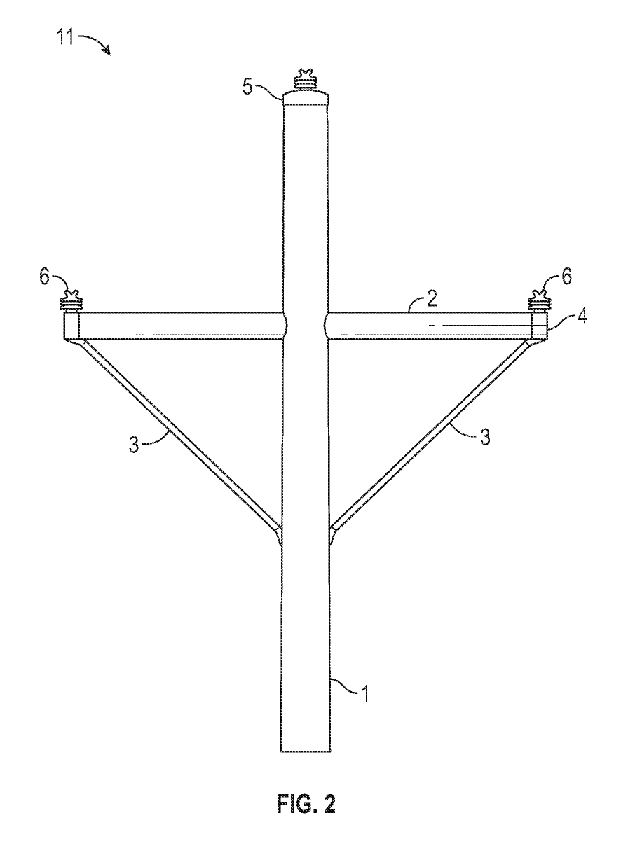

FIG. 2 shows a detailed view of the upper portion 11 of the utility pole 1. This embodiment includes a one piece composite cross bar 2, which supported by two smaller diameter composite cylinder support rods 3. On the ends of the cross bars are metallic or plastic end caps 4 bonded to the cross bar. On the top of the utility pole 1 is a metallic or plastic top end cap 5. The powerline insulators 6 are fastened to the cross bar and top end caps. In some embodiments of the composite utility pole 1, the composite cross bar 2 is not used. Instead, the powerline insulators 6, and other utility equipment (not shown), are fastened directly to the cylinder wall of the pole 1 using threaded inserts (not shown) embedded within the composite laminate.

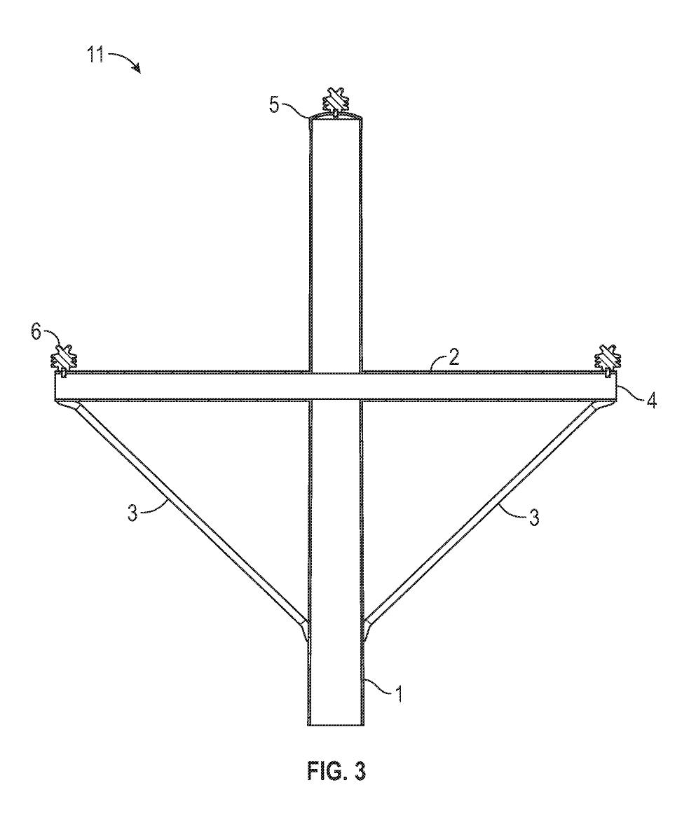

FIG. 3 shows a section view of the upper portion 11 of the utility pole 1. As shown in this section view the composite cylinders have a varying laminate and wall thickness. The cross bar 2 is a one piece composite cylinder passing through and centered about the axis of the utility pole 1. The utility pole 1 is tapered with the larger diameter at the bottom of the pole 7. The laminate design at the top 11 of the utility pole 1 is varying thickness. The thickness of the pole 1 laminate is based on a strength analysis of the bending load induced on the utility pole due to the worst case wind loading specified in National Electrical Safety Code (NESC) C2-2017 standard.

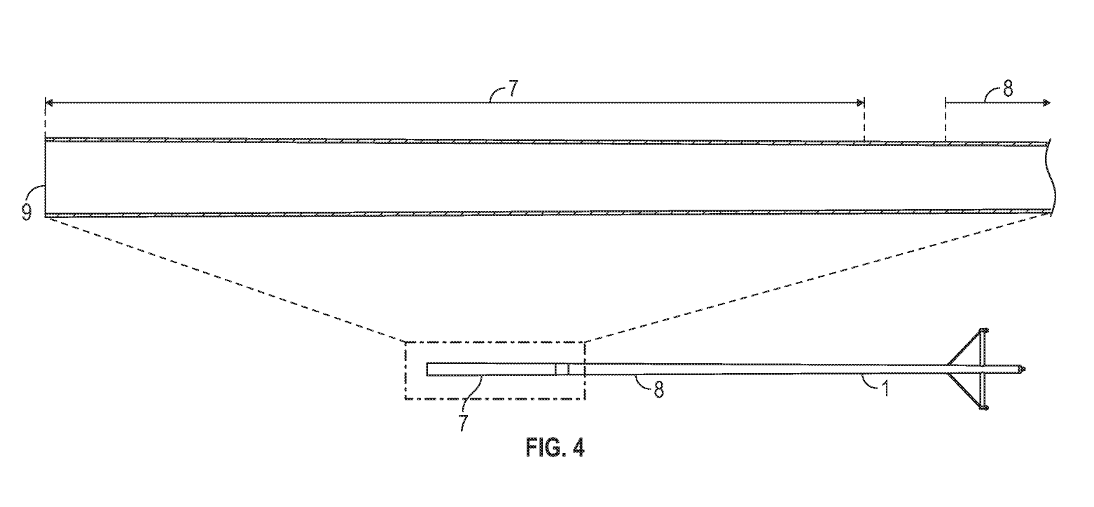

FIG. 4 shows a section view of the lower portion 7 of a utility pole 1. In this base section 7 of the pole 1, the laminate design has additional composite plies to react the highest bending load at the interface to the ground. The thicker laminate is extended up the pole 1 from the ground level approximately four feet. This increased thickness provides additional strength to react a possible vehicle crash into the base portion 7 of the installed utility pole 1. The midsection region 8 is a constant thickness laminate that continues to the top 10 of the utility pole 1. In addition, the composite laminate design, or helical winding angles, are optimized with a higher percentage of low angle (5° to 30°) helicals to efficiently react the high bending loads at the base section 7 of the pole 1.

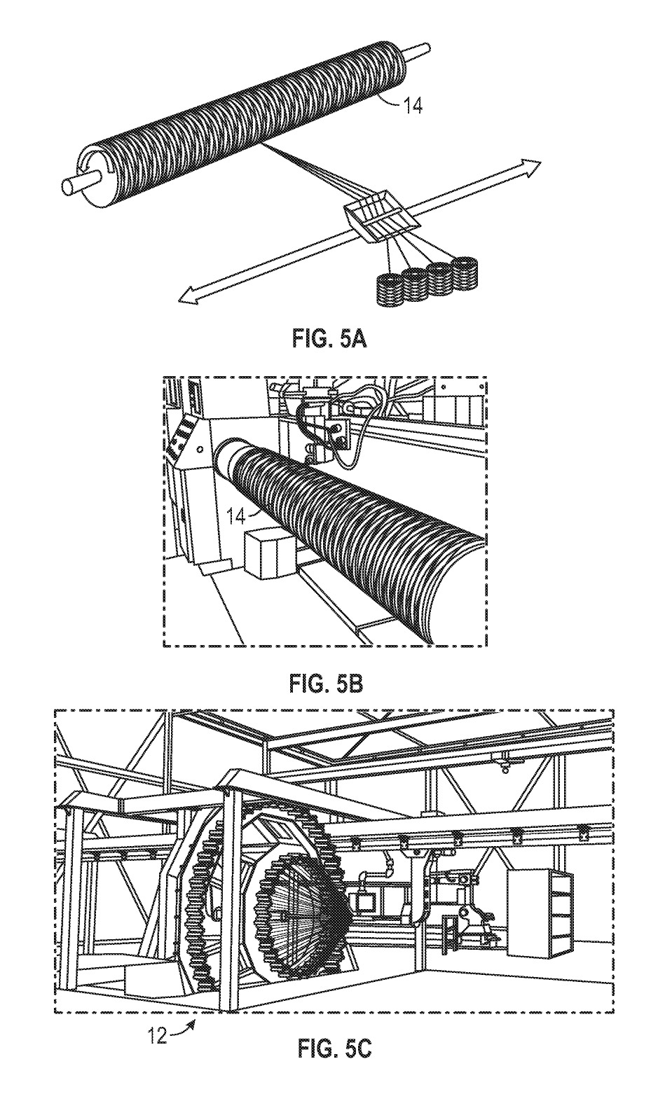

Embodiments of the composite filament winding manufacturing approach utilize a high production rate Ring or Spiral Filament Winding Machine. FIG. 5C shows an example Spiral or Ring Filament Winding Machine 12, and FIGS. 5A-B show a conventional winding machine. With this exemplary manufacturing approach, a multitude of composite plies with varying winding angles can be produced with one pass of the Ring Winding Machine 12, as the winding mandrel (e.g., similar to mandrel 14) is moved, while rotating, through the Ring Winding Machine 12. With this exemplary manufacturing approach, a 46 foot utility pole 1 may be wound in 15 to 20 minutes, compared to nearly 8 hours to wind a pole using a conventional filament winding machine. For embodiments with a larger percentage of low angle helicals, the Ring Winding Machine 12 manufacturing approach is much faster in producing low angle laminate plies than a conventional filament winding. Typically, low angle helicals are the most time consuming plies for a conventional filament winding machine. This exemplary single pass method of the ring winding manufacturing approach is one reason for the significant reduction in winding times.

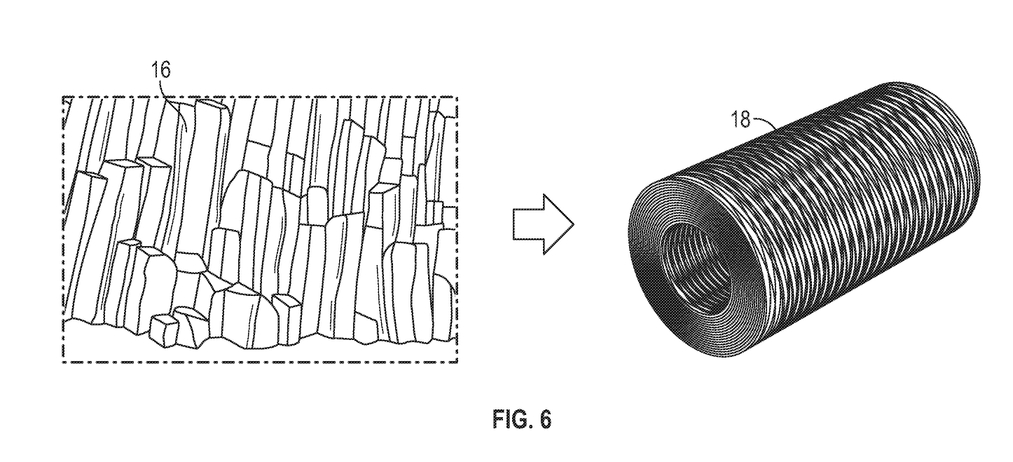

FIG. 6 is a schematic illustration of a natural fiber for use in the composite material. In embodiments of the disclosed pole 1, a natural occurring resource 16, such as basalt (i.e., igneous rock), may be turned into a fiber 18 for use in the composite material. For example, when heat (˜2550° F.) is applied to basalt, which is composed of the minerals plagioclase, pyroxene, and olivine, fibers 18 may be extruded, or otherwise formed. These fibers 18 are inherently UV light resistant, chemically resistant, noncombustible, dielectric, and REACH compliant, among other things. Embodiments may be mixed with a bio-resin, such as a pine-based resin, to comprise the composite material for utility poles 1. Soy-based resins may also be used. Embodiments of utility pole 1 may use a composite material of 20%-40% resin by weight, with 30% being preferred for some embodiments. Embodiments of utility pole 1 using bio-resins reduce the green-house gas emissions by approximately 33% compared to standard epoxy-based resins. Other advantages also exist.

In an exemplary embodiment, a utility pole 1 in accordance with a Class 5, forty foot pole, may be manufactured using the herein disclosed materials and methods to create a forty foot composite pole that weighs 251 pounds, is 136% stronger than an equivalent wood pole, and has 50% less deflection at load than an equivalent wood pole. Other advantages also exist.

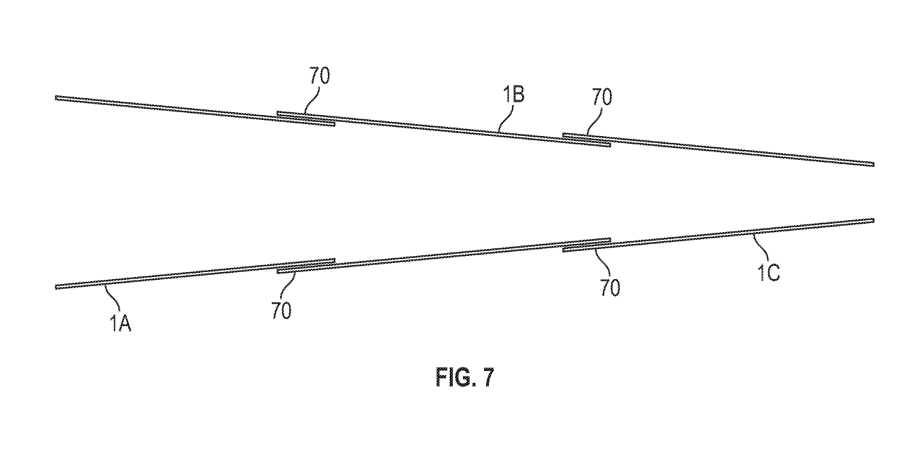

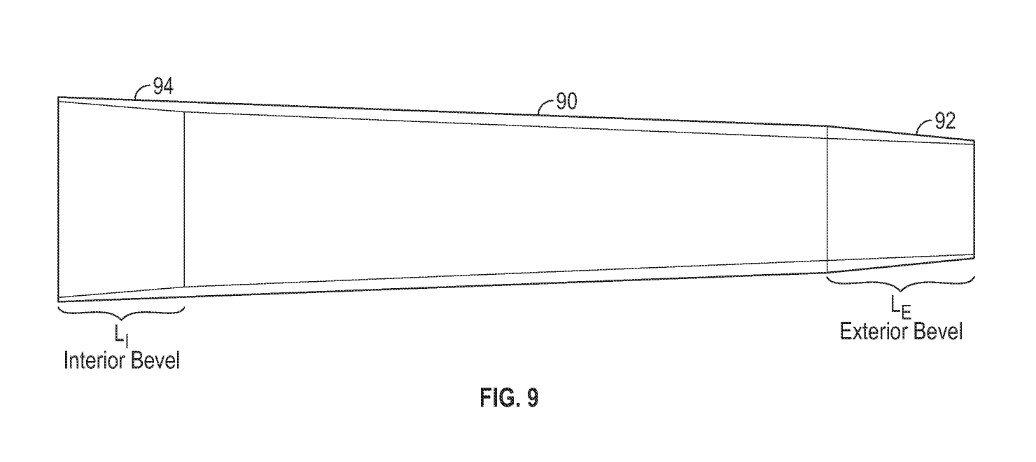

In some embodiments of the composite utility pole 1, a variant design of a plurality of nested, tapered, cylindrical multi-part poles 1A, 1B, 1C, etc., as shown in FIG. 7, are utilized. These segmented poles 1A, 1B, 1C can be hand carried into limited access locations and erected by two men without heavy equipment. As indicated at 70 the segments 1A, 1B, 1C, may be chemically bonded to each other to fasten the segments together to form a larger pole of modular construction. In some embodiments, the segments may also be beveled at the ends as discussed below with reference to FIG. 9. Other advantages also exist.

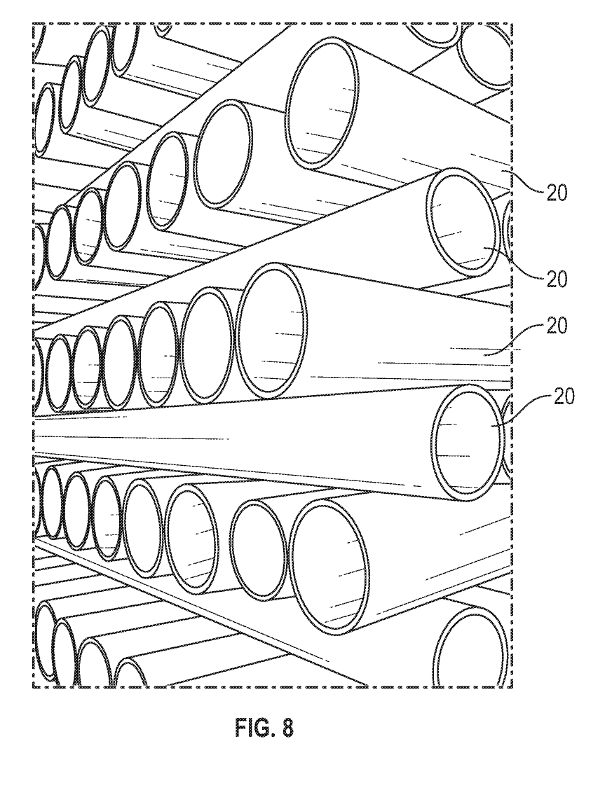

FIG. 8 is an illustration of a number of hollow cylinders 20 manufactured in accordance with disclosed embodiments. Cylinders 20 may be substantially un-tapered, or otherwise shaped, to function, for example, as water pipes, marine pilings, lamp poles, high pressure pipes, or the like. Other configurations and uses are possible and will be evident to those of skill in the art having the benefit of this disclosure.

FIG. 9 is a schematic cross-sectional illustration of pole with beveled ends in accordance with disclosed embodiments. As shown pole 90 (which also may be a segment of a pole such as 1A-C shown in FIG. 7) may have an exterior bevel 92 at one end. As illustrated, an exterior bevel 92 is one that the outer diameter of the exterior of the pole 90 decreases over a length LE of the pole. As also illustrated, pole 90 may have an interior bevel 94 on the other end of the pole 90. As illustrated, an interior bevel 94 is one that the inner diameter of the interior of the pole 90 decreases over a length L_{I} of the pole. As one of ordinary skill having the benefit of this disclosure would understand, poles 90 may be fashioned with interior bevels 94 and exterior bevels 92 on one end of a pole 90, on both ends, one each on opposite ends, and other configurations as desired.

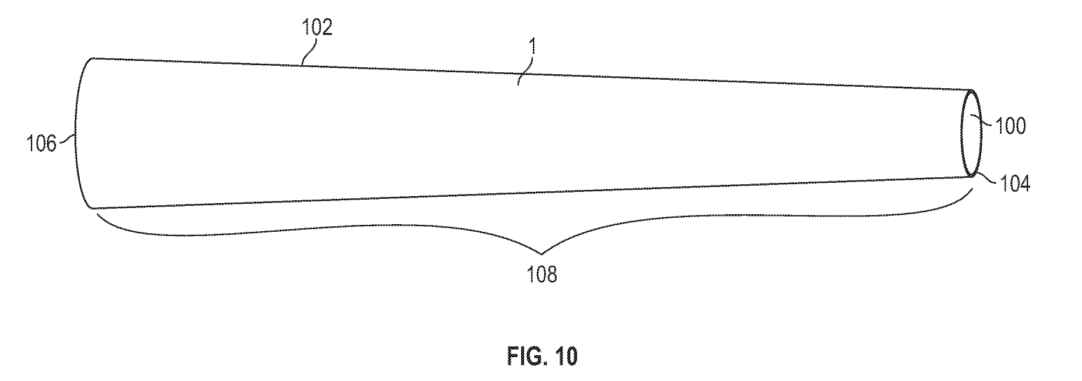

FIG. 10 is a schematic view of a tapered pole 1 in accordance with disclosed embodiments. As shown, a hollow tapered composite utility pole 1 includes a plurality of fibrous rovings reinforcing a plastic matrix (not shown in FIG. 10) forming a hollow pole 1 having an interior surface 100 and an exterior surface 102 and further having a narrow end 104, a wide end 106, and a taper portion 108 extending between the narrow end 104 and the wide end 106. As one of ordinary skill having the benefit of this disclosure would understand, poles 1 of any length, thickness, taper, width, shape, or the like may be manufactured as desired.

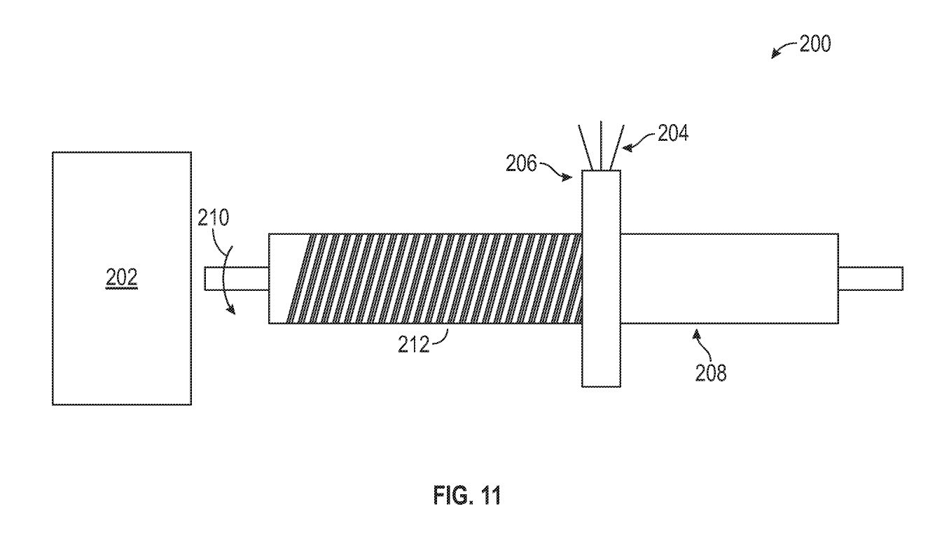

FIG. 11 is a schematic side view of a ring winding system 200 and process in accordance with disclosed embodiments. As also shown in FIG. 5C, a ring winding system 200 may include a ring winder 202 having a number of resonated fiber rovings 204 mounted on a number of spools (not shown in FIG. 11). The resonated fiber rovings 204 are delivered to a delivery ring 206 that moves from end-to-end along a mandrel 208. As the mandrel 208 rotates in direction 210 the resonated fiber rovings 204 are laid down in a helical fashion as indicated at 212 at an angle dictated by, among other things, the speed of rotation of the mandrel 208 in the direction of rotation 210 and the speed of travel of the delivery ring 206 along the mandrel 208.

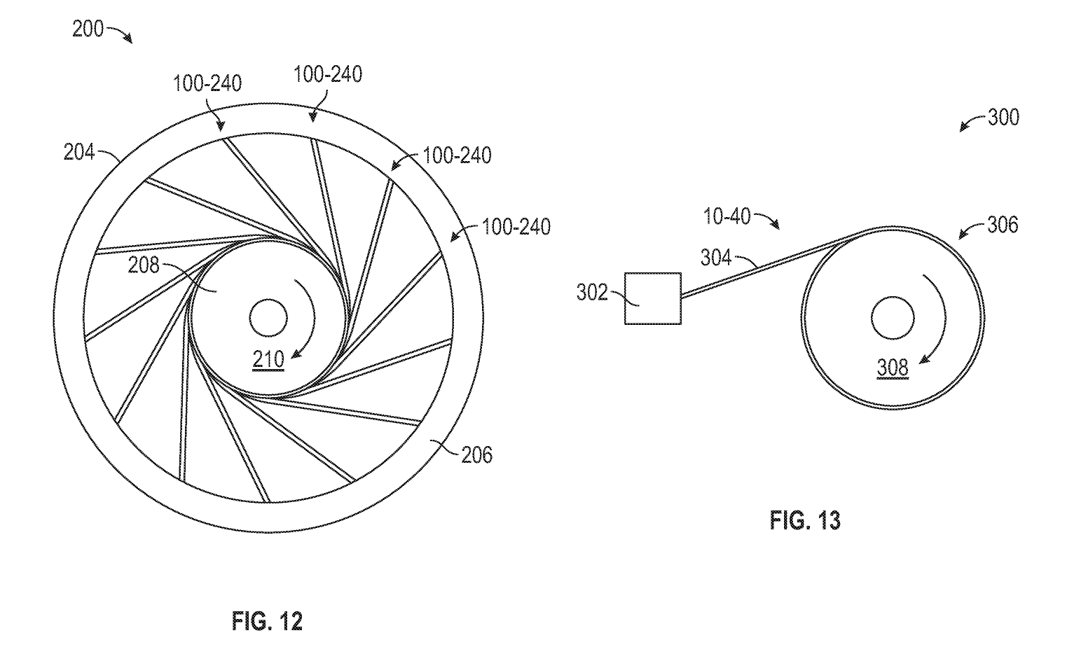

FIG. 12 is a schematic end view of a ring winding system 200 and process of FIG. 11 in accordance with disclosed embodiments. As shown, delivery ring 206 may deliver a significant number of rovings, e.g., 100-240, to mandrel 208.

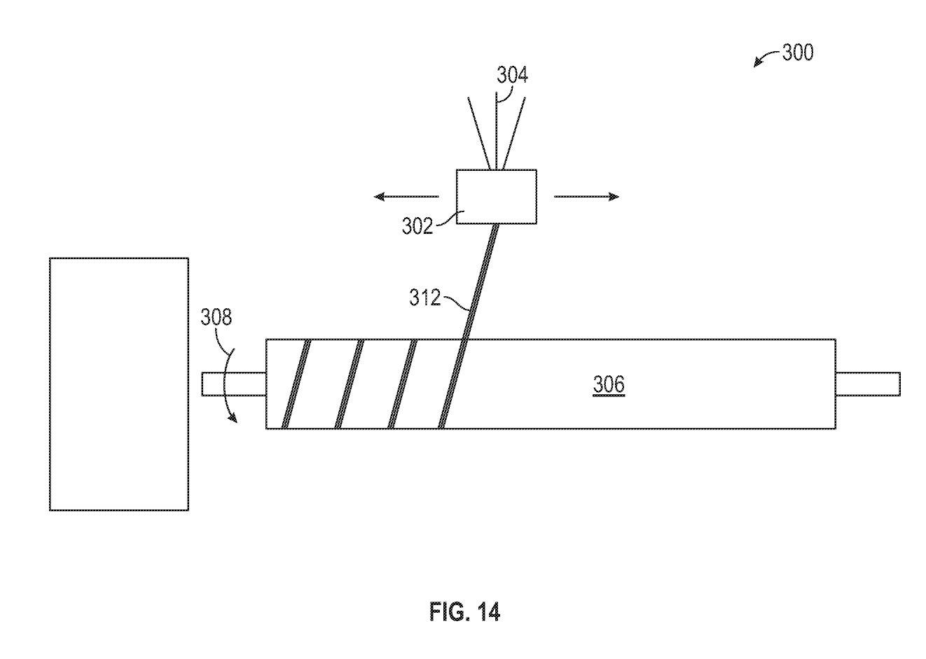

FIG. 13 is a schematic end view of a conventional filament winding system 300 and process of FIG. 14 in accordance with disclosed embodiments. While the ring winding system 200 is, among other things, faster, more economical, and more efficient, at manufacturing poles in accordance with this disclosure, it is also possible to manufacture them on conventional filament winding systems 300. As shown in FIG. 13 (and FIGS. 5A-B) a single delivery head 302 delivers rovings 304 to a mandrel 306 that is rotating in direction 308. Delivery head 302 moves along the length of the mandrel 306 to lay down the rovings in a helical fashion. In this type of system 300 approximately 10-40 rovings 304 may be delivered at a time.

FIG. 14 is a side view schematic of a convention filament winding system 300 in accordance with disclosed embodiments. As shown the back-and-forth motion of the delivery head 302 delivers the rovings 304 in a helical fashion as indicated at 312.

Although various embodiments have been shown and described, the present disclosure is not so limited and will be understood to include all such modifications and variations are would be apparent to one skilled in the art.

What is claimed is:

1. A hollow tapered composite utility pole comprising:
a plurality of fibrous rovings reinforcing a plastic matrix forming a hollow pole having an interior surface and an exterior surface and comprising:
a narrow end;
a wide end; and
a taper portion extending between the narrow end and the wide end.

2. The hollow tapered composite utility pole of claim 1 further comprising:
a first bevel on the exterior surface of the pole at the narrow end;
a second bevel on the interior surface of the pole at the wide end; and
wherein the first bevel and the second bevel are configured to couple and allow poles of varying sizes to be mated.

3. The hollow tapered composite utility pole of claim 2 further comprising:
a chemical bonding agent applied to at least one of the first bevel or the second bevel to couple the first bevel and the second bevel and to form a larger pole of modular construction.

4. The hollow tapered composite utility pole of claim 1 wherein said plurality of fibrous rovings are applied 100-240 at a time.

5. The hollow tapered composite utility pole of claim 1 wherein said plurality of fibrous rovings are applied simultaneously and in a circumferential, manner to the longitudinal axis of a forming mandrel.

6. A method of manufacturing a tapered composite utility pole, the method comprising:
ring winding a plurality of fibrous rovings reinforcing a plastic matrix to form a hollow pole having an interior surface and an exterior surface and comprising:
a narrow end;
a wide end; and
a taper portion extending between the narrow end and the wide end.

7. The method of claim 6 wherein said plurality of fibrous rovings are applied 100-240 at a time, and are applied simultaneously and in a circumferential, manner to the longitudinal axis of a forming mandrel.

8. The method of claim 6 further comprising:
forming a first bevel on the exterior surface of the pole at the narrow end;
forming a second bevel on the interior surface of the pole at the wide end; and
wherein the first bevel and the second bevel are configured to couple and allow poles of varying sizes to be mated.

9. The method of claim 8 further comprising:
chemically bonding at least one of the first bevel or the second bevel to couple the first bevel and the second bevel and to form a larger pole of modular construction.
